(19) United States
(12) Patent Application Publication
(10) Pub. No.: US 2024/0021866 A1
(43) Pub. Date: Jan. 18, 2024

(54) SOLID-STATE INTERLAYERS FOR ELECTROCHEMICAL CELLS INCLUDING LIQUID ELECTROLYTES

(71) Applicant: GM GLOBAL TECHNOLOGY OPERATIONS LLC, Detroit, MI (US)

(72) Inventors: Zhe LI, Shanghai (CN); Qili SU, Shanghai (CN); Jingyuan LIU, Shanghai (CN); Haijing LIU, Shanghai (CN); Mark W. VERBRUGGE, Troy, MI (US)

(73) Assignee: GM GLOBAL TECHNOLOGY OPERATIONS LLC, Detroit, MI (US)

(21) Appl. No.: 17/941,299

(22) Filed: Sep. 9, 2022

(30) Foreign Application Priority Data
Jul. 12, 2022 (CN) 202210817744.7

(51) Int. Cl. H01M 10/0562; H01M 10/0525; H01M 50/449

(52) U.S. Cl. CPC H01M 10/0562; H01M 10/0525; H01M 50/449; H01M 2300/0068; H01M 2300/0077

(57) ABSTRACT

The present disclosure provides an electrochemical cell that cycles lithium ions. The electrochemical cell includes a first electrode, a second electrode, a separator physically separating the first and second electrodes, a solid-state interlayer disposed between the separator and the first electrode, and a liquid electrolyte disposed in each of the first electrode, the second electrode, the separator, and the solid-state interlayer. The solid-state interlayer includes a plurality of solid-state electrolyte particles. The solid-state interlayer covers greater than or equal to about 85% of a total surface area of the surface of the first electrode.

### CROSS-REFERENCE TO RELATED APPLICATIONS

This application claims the benefit and priority of Chinese Application No. 202210817744.7 filed Jul. 12, 2022. The entire disclosure of the above application is incorporated herein by reference.

### INTRODUCTION

This section provides background information related to the present disclosure which is not necessarily prior art.

Advanced energy storage devices and systems are in demand to satisfy energy and/or power requirements for a variety of products, including automotive products such as start-stop systems (e.g., 12V start-stop systems), battery-assisted systems, hybrid electric vehicles (“HEVs”), and electric vehicles (“EVs”). Typical lithium-ion batteries include two electrodes and an electrolyte component and/or separator. One of the two electrodes can serve as a positive electrode or cathode, and the other electrode can serve as a negative electrode or anode. Lithium-ion batteries may also include various terminal and packaging materials. Rechargeable lithium-ion batteries operate by reversibly passing lithium ions back and forth between the negative electrode and the positive electrode. For example, lithium ions may move from the positive electrode to the negative electrode during charging of the battery and in the opposite direction when discharging the battery. A separator and/or electrolyte may be disposed between the negative and positive electrodes. The electrolyte is suitable for conducting lithium ions between the electrodes.

### SUMMARY

This section provides a general summary of the disclosure, and is not a comprehensive disclosure of its full scope or all of its features.

The present disclosure relates to solid-state interlayers for electrochemical cells that include liquid electrolytes, and also to methods of making and using the same.

In various aspects, the present disclosure provides an electrochemical cell that cycles lithium ions. The electrochemical cell may include an electrode, a solid-state interlayer, and a liquid electrolyte disposed in the electrode and solid-state interlayer. The solid-state interlayer may include a plurality of solid-state electrolyte particles disposed on or adjacent to a surface of the electrode.

In one aspect, the solid-state electrolyte particles may have an average particle size greater than or equal to about 0.02 micrometers to less than or equal to about 20 micrometers. The solid-state interlayer may have an average thickness greater than or equal to about 0.5 micrometers to less than or equal to about 40 micrometers.

In one aspect, the solid-state interlayer may cover greater than or equal to about 85% of a total surface area of the surface of the electrode.

In one aspect, the solid-state particles may include Li₁₊ₓAlₓTi₂₋ₓ(PO₄)₃, where 0≤x≤2 (LATP) or Li₇La₃Zr₂O₁₂.

In one aspect, the solid-state particles may include oxide-based solid-state particles, metal-doped or aliovalent-substituted oxide solid-state particles, sulfide-based solid-state particles, nitride-based solid-state particles, halide-based solid-state particles, borate-based solid-state particles, or combinations thereof.

In one aspect, the solid-state interlayer may include greater than or equal to about 80 wt. % to less than or equal to about 100 wt. % of the solid-state electrolyte particles, and greater than or equal to about 0 wt. % to less than or equal to about 20 wt. % of a polymeric binder.

In one aspect, the electrode may be a positive electrode.

In one aspect, the electrode may be a negative electrode.

In one aspect, the electrode may be a first electrode, and the electrochemical cell may further include a second electrode disposed parallel with the first electrode, and a separator disposed between the solid-state interlayer and the second electrode. The liquid electrolyte may also be disposed in the separator and the second electrode.

In one aspect, the solid-state interlayer may be a first solid-state interlayer, the plurality of solid-state electrolyte particles may be a first plurality of solid-state electrolyte particles, and the electrochemical cell may further include a second solid-state interlayer disposed between the separator and the second electrode. The second solid-state interlayer may include a second plurality of solid-state particles. The second solid-state interlayer may cover greater than or equal to about 85% of a total surface area of a surface of the second electrode opposing the separator. The second solid-state interlayer may be the same as or different form the first solid-state interlayer. The liquid electrolyte may also be disposed in second solid-state interlayer.

In various aspects, the present disclosure may provide an electrochemical cell that cycles lithium ions. The electrochemical cell may include a first electrode, a second electrode, a separator physically separating the first and second electrodes, a solid-state interlayer disposed between the separator and the first electrode, and a liquid electrolyte disposed in each of the first electrode, the second electrode, the separator, and the solid-state interlayer. The solid-state interlayer may include a plurality of solid-state electrolyte particles.

In one aspect, the solid-state electrolyte particles may have an average particle size greater than or equal to about 0.02 micrometers to less than or equal to about 20 micrometers, and the solid-state interlayer may have an average thickness greater than or equal to about 0.5 micrometers to less than or equal to about 30 micrometers.

In one aspect, the solid-state particles may be selected from the group consisting of: Li₁₊ₓAlₓTi₂₋ₓ(PO₄)₃, where 0≤x≤2 (LATP), Li₇La₃Zr₂O₁₂, other oxide-based solid-state particles, metal-doped or aliovalent-substituted oxide solid-state particles, sulfide-based solid-state particles, nitride-based solid-state particles, halide-based solid-state particles, borate-based solid-state particles, and combinations thereof

In one aspect, the solid-state interlayer may include greater than or equal to about 80 wt. % to less than or equal to about 100 wt. % of the solid-state electrolyte particles, and greater than or equal to about 0 wt. % to less than or equal to about 20 wt. % of a polymeric binder.

In one aspect, the solid-state interlayer may be a first solid-state interlayer, the plurality of solid-state electrolyte particles may be a first plurality of solid-state electrolyte particles, and the electrochemical cell may further include a second solid-state interlayer. The second solid-state interlayer may include a second plurality of solid-state electrolyte particles disposed between the separator and the second electrode. The second solid-state interlayer may be the same as or different from the first solid-state interlayer. The liquid electrolyte may also be disposed in the second solid-state interlayer.

In various aspects, the present disclosure provides a separator for an electrochemical cell that cycles lithium ions. The separator may include a porous layer having a porosity greater than or equal to about 5 vol. % to less than or equal to about 100 vol. %, a solid-state interlayer that includes a plurality of solid-state electrolyte particles disposed on a surface of the porous layer, and a liquid electrolyte disposed in the porous layer and the solid-state interlayer.

In one aspect, the solid-state electrolyte particles may have an average particle size greater than or equal to about 0.02 micrometers to less than or equal to about 20 micrometers, and the solid-state interlayer may have an average thickness greater than or equal to about 0.5 micrometers to less than or equal to about 40 micrometers.

In one aspect, the solid-state particles may be selected from the group consisting of: Li₁₊ₓAlₓTi₂₋ₓ(PO₄)₃, where 0≤x≤2 (LATP), Li₇La₃Zr₂O₁₂, other oxide-based solid-state particles, metal-doped or aliovalent-substituted oxide solid-state particles, sulfide-based solid-state particles, nitride-based solid-state particles, halide-based solid-state particles, borate-based solid-state particles, and combinations thereof

In one aspect, the solid-state interlayer may include greater than or equal to about 80 wt. % to less than or equal to about 100 wt. % of the solid-state electrolyte particles, and greater than or equal to about 0 wt. % to less than or equal to about 20 wt. % of a polymeric binder.

In one aspect, the surface of the porous layer may be a first surface, the solid-state interlayer may be a first solid-state interlayer, the plurality of solid-state electrolyte particles may be a first plurality of solid-state particles, and the separator may further include a second solid-state interlayer. The second solid-state interlayer may include a second plurality of solid-state electrolyte particles disposed on a second surface of the porous layer. The second surface may be parallel with the first surface. The second solid-state interlayer may be the same as or different from the first solid-state interlayer. The liquid electrolyte may also be disposed in the second solid-state interlayer.

Further areas of applicability will become apparent from the description provided herein. The description and specific examples in this summary are intended for purposes of illustration only and are not intended to limit the scope of the present disclosure.

### BRIEF DESCRIPTION OF THE DRAWINGS

The drawings described herein are for illustrative purposes only of selected embodiments and not all possible implementations, and are not intended to limit the scope of the present disclosure.

FIG. 1 is an illustration of an example electrochemical cell including a solid-state interlayer in accordance with various aspects of the present disclosure;

FIG. 2 is an illustration of another example electrochemical cell including a solid-state interlayer in accordance with various aspects of the present disclosure;

FIG. 3 is an illustration of an example electrochemical cell including first and second solid-state interlayers in accordance with various aspects of the present disclosure;

FIG. 4 is a graphical illustration demonstrating the results of a differential scanning calorimetry (DSC) test for an example battery cell including a solid-state interlayer in accordance with various aspects of the present disclosure;

FIG. 5 is a graphical illustration demonstrating discharge rate capability of an example battery cell including a solid-state interlayer in accordance with various aspects of the present disclosure; and

FIG. 6 is a graphical illustration demonstrating low-temperature discharge of an example battery cell including a solid-state interlayer in accordance with various aspects of the present disclosure.

Corresponding reference numerals indicate corresponding parts throughout the several views of the drawings.

### DETAILED DESCRIPTION

Example embodiments are provided so that this disclosure will be thorough, and will fully convey the scope to those who are skilled in the art. Numerous specific details are set forth such as examples of specific compositions, components, devices, and methods, to provide a thorough understanding of embodiments of the present disclosure. It will be apparent to those skilled in the art that specific details need not be employed, that example embodiments may be embodied in many different forms and that neither should be construed to limit the scope of the disclosure. In some example embodiments, well-known processes, well-known device structures, and well-known technologies are not described in detail.

The terminology used herein is for the purpose of describing particular example embodiments only and is not intended to be limiting. As used herein, the singular forms “a,” “an,” and “the” may be intended to include the plural forms as well, unless the context clearly indicates otherwise. The terms “comprises,” “comprising,” “including,” and “having,” are inclusive and therefore specify the presence of stated features, elements, compositions, steps, integers, operations, and/or components, but do not preclude the presence or addition of one or more other features, integers, steps, operations, elements, components, and/or groups thereof Although the open-ended term “comprising,” is to be understood as a non-restrictive term used to describe and claim various embodiments set forth herein, in certain aspects, the term may alternatively be understood to instead be a more limiting and restrictive term, such as “consisting of” or “consisting essentially of.” Thus, for any given embodiment reciting compositions, materials, components, elements, features, integers, operations, and/or process steps, the present disclosure also specifically includes embodiments consisting of, or consisting essentially of, such recited compositions, materials, components, elements, features, integers, operations, and/or process steps. In the case of “consisting of,” the alternative embodiment excludes any additional compositions, materials, components, elements, features, integers, operations, and/or process steps, while in the case of “consisting essentially of,” any additional compositions, materials, components, elements, features, integers, operations, and/or process steps that materially affect the basic and novel characteristics are excluded from such an embodiment, but any compositions, materials, components, elements, features, integers, operations, and/or process steps that do not materially affect the basic and novel characteristics can be included in the embodiment.

Any method steps, processes, and operations described herein are not to be construed as necessarily requiring their performance in the particular order discussed or illustrated, unless specifically identified as an order of performance. It is also to be understood that additional or alternative steps may be employed, unless otherwise indicated.

When a component, element, or layer is referred to as being “on,” “engaged to,” “connected to,” or “coupled to” another element or layer, it may be directly on, engaged, connected, or coupled to the other component, element, or layer, or intervening elements or layers may be present. In contrast, when an element is referred to as being “directly on,” “directly engaged to,” “directly connected to,” or “directly coupled to” another element or layer, there may be no intervening elements or layers present. Other words used to describe the relationship between elements should be interpreted in a like fashion (e.g., “between” versus “directly between,” “adjacent” versus “directly adjacent,” etc.). As used herein, the term “and/or” includes any and all combinations of one or more of the associated listed items.

Although the terms first, second, third, etc. may be used herein to describe various steps, elements, components, regions, layers and/or sections, these steps, elements, components, regions, layers and/or sections should not be limited by these terms, unless otherwise indicated. These terms may be only used to distinguish one step, element, component, region, layer or section from another step, element, component, region, layer, or section. Terms such as “first,” “second,” and other numerical terms when used herein do not imply a sequence or order unless clearly indicated by the context. Thus, a first step, element, component, region, layer, or section discussed below could be termed a second step, element, component, region, layer, or section without departing from the teachings of the example embodiments.

Spatially or temporally relative terms, such as “before,” “after,” “inner,” “outer,” “beneath,” “below,” “lower,” “above,” “upper,” and the like, may be used herein for ease of description to describe one element or feature's relationship to another element(s) or feature(s) as illustrated in the figures. Spatially or temporally relative terms may be intended to encompass different orientations of the device or system in use or operation in addition to the orientation depicted in the figures.

Throughout this disclosure, the numerical values represent approximate measures or limits to ranges to encompass minor deviations from the given values and embodiments having about the value mentioned as well as those having exactly the value mentioned. Other than in the working examples provided at the end of the detailed description, all numerical values of parameters (e.g., of quantities or conditions) in this specification, including the appended claims, are to be understood as being modified in all instances by the term “about” whether or not “about” actually appears before the numerical value. “About” indicates both exactly or precisely the stated numerical value, and also, that the stated numerical value allows some slight imprecision (with some approach to exactness in the value; approximately or reasonably close to the value; nearly). If the imprecision provided by “about” is not otherwise understood in the art with this ordinary meaning, then “about” as used herein indicates at least variations that may arise from ordinary methods of measuring and using such parameters. For example, “about” may comprise a variation of less than or equal to 5%, optionally less than or equal to 4%, optionally less than or equal to 3%, optionally less than or equal to 2%, optionally less than or equal to 1%, optionally less than or equal to 0.5%, and in certain aspects, optionally less than or equal to 0.1%.

In addition, disclosure of ranges includes disclosure of all values and further divided ranges within the entire range, including endpoints and sub-ranges given for the ranges.

Example embodiments will now be described more fully with reference to the accompanying drawings.

The present technology relates to electrochemical cells including solid-state interlayers and liquid electrolytes, as well as methods of making and using the same. Such cells can be used in vehicle or automotive transportation applications (e.g., motorcycles, boats, tractors, buses, motorcycles, mobile homes, campers, and tanks). However, the present technology may also be employed in a wide variety of other industries and applications, including aerospace components, consumer goods, devices, buildings (e.g., houses, offices, sheds, and warehouses), office equipment and furniture, and industrial equipment machinery, agricultural or farm equipment, or heavy machinery, by way of non-limiting example. Further, although the illustrated examples detail below include a single positive electrode cathode and a single anode, the skilled artisan will recognize that the present teachings also extend to various other configurations, including those having one or more cathodes and one or more anodes, as well as various current collectors with electroactive layers disposed on or adjacent to one or more surfaces thereof.

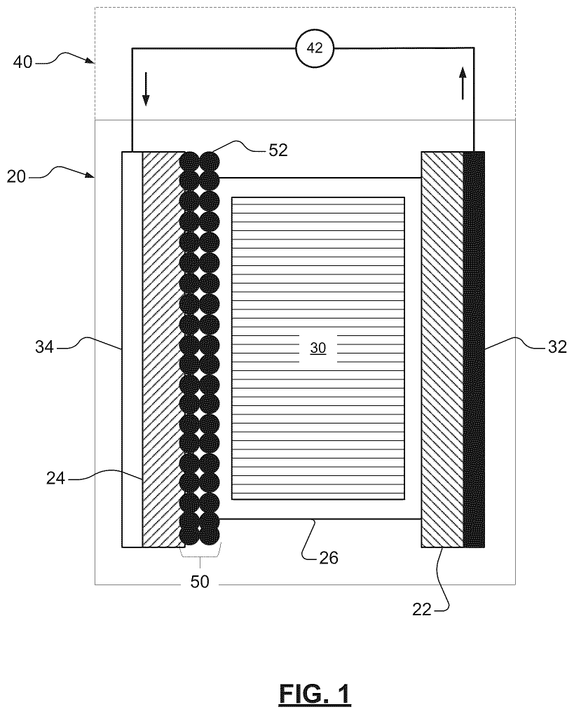

An exemplary and schematic illustration of an electrochemical cell (also referred to as a battery) 20 is shown in FIG. 1. The battery 20 includes a negative electrode 22 (e.g., anode), a positive electrode 24 (e.g., cathode), and a separator 26 disposed between the two electrodes 22, 24. The battery 20 may also include a solid-state interlayer 50 that is disposed between the positive electrode 24 and the separator 26. The separator 26, and also the solid-state interlayer 50, provide electrical separation—prevents physical contact—between the electrodes 22, 24. The separator 26 and solid-state interlayer 50 provides a minimal resistance path for internal passage of lithium ions, and in certain instances, related anions, during cycling of the lithium ions. In various aspects, the separator 26 comprises an electrolyte 30 that may, in certain aspects, also be present in the solid-state interlayer 50, the negative electrode 22, and/or the positive electrode 24, so as to form a continuous electrolyte network.

A first current collector 32 (e.g., a negative current collector) may be positioned at or near the negative electrode 22. The first current collector 32 may be a metal foil, metal grid or screen, or expanded metal comprising copper or any other appropriate electrically conductive material known to those of skill in the art. A second current collector 34 (e.g., a positive current collector) may be positioned at or near the positive electrode 24. The second electrode current collector 34 may be a metal foil, metal grid or screen, or expanded metal comprising aluminum or any other appropriate electrically conductive material known to those of skill in the art. The first current collector 32 and the second current collector 34 may respectively collect and move free electrons to and from an external circuit 40. For example, an interruptible external circuit 40 and a load device 42 may connect the negative electrode 22 (through the first current collector 32) and the positive electrode 24 (through the second current collector 34).

The battery 20 can generate an electric current during discharge by way of reversible electrochemical reactions that occur when the external circuit 40 is closed (to connect the negative electrode 22 and the positive electrode 24) and the negative electrode 22 has a lower potential than the positive electrode. The chemical potential difference between the positive electrode 24 and the negative electrode 22 drives electrons produced by a reaction, for example, the oxidation of intercalated lithium, at the negative electrode 22 through the external circuit 40 toward the positive electrode 24. Lithium ions that are also produced at the negative electrode 22 are concurrently transferred through the electrolyte 30 contained in the separator 26 toward the positive electrode 24. The electrons flow through the external circuit 40 and the lithium ions migrate across the separator 26 containing the electrolyte 30 to form intercalated lithium at the positive electrode 24. As noted above, the electrolyte 30 is typically also present in the negative electrode 22 and positive electrode 24. The electric current passing through the external circuit 40 can be harnessed and directed through the load device 42 until the lithium in the negative electrode 22 is depleted and the capacity of the battery 20 is diminished.

The battery 20 can be charged or re-energized at any time by connecting an external power source to the lithium ion battery 20 to reverse the electrochemical reactions that occur during battery discharge. Connecting an external electrical energy source to the battery 20 promotes a reaction, for example, non-spontaneous oxidation of intercalated lithium, at the positive electrode 24 so that electrons and lithium ions are produced. The lithium ions flow back toward the negative electrode 22 through the electrolyte 30 across the separator 26 to replenish the negative electrode 22 with lithium (e.g., intercalated lithium) for use during the next battery discharge event. As such, a complete discharging event followed by a complete charging event is considered to be a cycle, where lithium ions are cycled between the positive electrode 24 and the negative electrode 22. The external power source that may be used to charge the battery 20 may vary depending on the size, construction, and particular end-use of the battery 20. Some notable and exemplary external power sources include, but are not limited to, an AC-DC converter connected to an AC electrical power grid though a wall outlet and a motor vehicle alternator.

In many lithium-ion battery configurations, each of the first current collector 32, negative electrode 22, separator 26, positive electrode 24, and second current collector 34 are prepared as relatively thin layers (for example, from several microns to a fraction of a millimeter or less in thickness) and assembled in layers connected in electrical parallel arrangement to provide a suitable electrical energy and power package. In various aspects, the battery 20 may also include a variety of other components that, while not depicted here, are nonetheless known to those of skill in the art. For instance, the battery 20 may include a casing, gaskets, terminal caps, tabs, battery terminals, and any other conventional components or materials that may be situated within the battery 20, including between or around the negative electrode 22, the positive electrode 24, and/or the separator 26.

The size and shape of the battery 20 may vary depending on the particular application for which it is designed. Battery-powered vehicles and hand-held consumer electronic devices, for example, are two examples where the battery 20 would most likely be designed to different size, capacity, and power-output specifications. The battery 20 may also be connected in series or parallel with other similar lithium-ion cells or batteries to produce a greater voltage output, energy, and power if it is required by the load device 42. Accordingly, the battery 20 can generate electric current to a load device 42 that is part of the external circuit 40. The load device 42 may be powered by the electric current passing through the external circuit 40 when the battery 20 is discharging. While the electrical load device 42 may be any number of known electrically-powered devices, a few specific examples include an electric motor for an electrified vehicle, a laptop computer, a tablet computer, a cellular phone, and cordless power tools or appliances. The load device 42 may also be an electricity-generating apparatus that charges the battery 20 for purposes of storing electrical energy.

With renewed reference to FIG. 1, the positive electrode 24, the negative electrode 22, and the separator 26 may each include an electrolyte solution or system 30 inside their pores, capable of conducting lithium ions between the negative electrode 22 and the positive electrode 24. For example, in certain aspects, the electrolyte 30 may be a non-aqueous liquid electrolyte solution (e.g., >1 M) that includes a lithium salt dissolved in an organic solvent or a mixture of organic solvents. Numerous conventional non-aqueous liquid electrolyte 30 solutions may be employed in the battery 20.

A non-limiting list of lithium salts that may be dissolved in an organic solvent to form the non-aqueous liquid electrolyte solution include lithium hexafluorophosphate (LiPF₆), lithium perchlorate (LiClO₄), lithium tetrachloroaluminate (LiAlCl₄), lithium iodide (LiI), lithium bromide (LiBr), lithium thiocyanate (LiSCN), lithium tetrafluoroborate (LiBF₄), lithium tetraphenylborate (LiB(C₆H₅)₄), lithium bis(oxalato)borate (LiB(C₂O₄)₂) (LiBOB), lithium difluorooxalatoborate (LiBF₂(C₂O₄)), lithium hexafluoroarsenate (LiAsF₆), lithium trifluoromethanesulfonate (LiCF₃SO₃), lithium bis(trifluoromethane)sulfonylimide (LiN(CF₃SO₂)₂), lithium bis(fluorosulfonyl)imide (LiN(FSO₂)₂) (LiSFI), and combinations thereof.

These and other similar lithium salts may be dissolved in a variety of non-aqueous aprotic organic solvents, including but not limited to, various alkyl carbonates, such as cyclic carbonates (e.g., ethylene carbonate (EC), propylene carbonate (PC), butylene carbonate (BC), fluoroethylene carbonate (FEC)), linear carbonates (e.g., dimethyl carbonate (DMC), diethyl carbonate (DEC), ethylmethylcarbonate (EMC)), aliphatic carboxylic esters (e.g., methyl formate, methyl acetate, methyl propionate), γ-lactones (e.g., γ-butyrolactone, γ-valerolactone), chain structure ethers (e.g., 1,2-di methoxy ethane, 1-2-di ethoxy ethane, ethoxymethoxyethane), cyclic ethers (e.g., tetrahydrofuran, 2-methyltetrahydrofuran), 1,3-dioxolane), sulfur compounds (e.g., sulfolane), and combinations thereof.

In certain variations, the separator 26 may be a polyolefin-based separator. For example, the polyolefin may be a homopolymer (derived from a single monomer constituent) or a heteropolymer (derived from more than one monomer constituent), which may be either linear or branched. If a heteropolymer is derived from two monomer constituents, the polyolefin may assume any copolymer chain arrangement, including those of a block copolymer or a random copolymer. Similarly, if the polyolefin is a heteropolymer derived from more than two monomer constituents, it may likewise be a block copolymer or a random copolymer. In certain variations, the polyolefin may include polyacetylene, polypropylene (PP), polyethylene (PE), or a combination thereof. For example, in the polyolefin-based separator may be a dual-layered separator including, for example, polypropylene-polyethylene. In other instances, the polyolefin-based separator may be a three-layered separator including, for example, polypropylene-polyethylene-polypropylene.

In other variations, the separator 26 may be a separator including, for example, a polyvinylidene fluoride (PVDF) membrane and/or a polyimide membrane. Further still, in certain instances, the separator 26 may be a high-temperature stable separator. For example, the separator 26 may be a polyimide nanofiber-based nonwoven separator; a non-sized, alumina (Al₂O₃) and poly(lithium 4-styrenesulfonate)-coated polyethylene membrane; a silica (SiO₂) coated polyethylene separator; a co-polyimide-coated polyethylene separator; a polyetherimides (PEI) (bisphenol-aceton diphthalic anhydride (BPADA) and para-phenylenediamine) separator, an expanded polytetrafluoroethylene reinforced polyvinylidenefluoride-hexafluoropropylene separator, a sandwiched-structure polyvinylidene fluoride (PVDF)-poly(m-phenylene isophthalamide) (PMIA)-polyvinylidene fluoride (PVDF) separator, and the like.

In each variation, the separator 26 may include a ceramic material and/or a heat-resistant material. For example, the separator 26 may also be admixed with the ceramic material and/or the heat-resistant material, or one or more surfaces of the separator 26 may be coated with the ceramic material and/or the heat-resistant material. In certain variations, the ceramic material and/or the heat-resistant material may be disposed on one or more sides of the separator 26. The ceramic material may include, for example, alumina (Al₂O₃) and/or silica (SiO₂). The heat-resistant material may include, for example, Nomex and/or Aramid.

The solid-state interlayer 50 is an electrochemically stable layer. For example, the solid-state interlayer 50 is capable of working stably at working voltages designated for the positive electrode. In certain variations, the oxidation onset voltage of solid-state interlayer 50 may be at the range of about 2.1 V to about 5.0 V vs. Li/Li⁺. The solid-state interlayer 50 may include a plurality of solid-state electrolyte particles 52. In certain variations, the solid-state electrolyte particles 52 may have an average particle size greater than or equal to about 0.02 μm to less than or equal to about 20 μm, and in certain aspects, optionally greater than or equal to about 0.1 μm to less than or equal to about 10 μm, and the solid-state interlayer 50 may have an average thickness that is at least two times the average solid-state electrolyte particle size. For example, the solid-state interlayer 50 may have an average thickness greater than or equal to about 0.5 μm to less than or equal to about 40 μm, optionally greater than or equal to about 0.5 μm to less than or equal to about 10 μm, and in certain aspects, optionally about 5 μm. The solid-state interlayer 50 may be substantially uniformed and continuous.

As noted above, the solid-state interlayers 50 helps to physical separator, and also, ensure electrical isolation, between the electrodes 22, 24, especially in situations of mechanical, electrical, or thermal abuse. The solid-state interlayer 50 may also help to enhance rate capabilities and low temperature performance. For example, during operation, the polarized solid-state electrolyte particles 52 can interact with lithium ions (Li⁺) to promote more dissociation of lithium salts (for example, in the electrolyte 30), thereby boosting lithium-ion transportation.

In certain variations, the solid-state electrolyte particles 52 may include, for example, Li₁₊ₓAlₓTi₂₋ₓ(PO₄)₃, where 0≤x≤2 (LATP). In other variations, the solid-state particles 52 may include, for example, oxide-based solid-state particles, metal-doped or aliovalent-substituted oxide solid-state particles, sulfide-based solid-state particles, nitride-based solid-state particles, halide-based solid-state particles, and/or borate-based solid-state particles. In still further variations, the solid-state electrolyte particles 52 may include, for example, a first plurality of solid-state electrolyte particles and a second plurality of solid-state electrolyte particles, where the first plurality comprises Li₁₊ₓAlₓTi₂₋ₓ(PO₄)₃, where 0≤x≤2 (LATP), and the second plurality comprises oxide-based solid-state particles, metal-doped or aliovalent-substituted oxide solid-state particles, sulfide-based solid-state particles, nitride-based solid-state particles, halide-based solid-state particles, and/or borate-based solid-state particles.

In each variation, the oxide-based solid-state particles may include garnet type solid-state particles (e.g., Li₇La₃Zr₂O₁₂), perovskite type solid-state particles (e.g. Li₃ₓLa_{2/3-x}TiO₃, where 0<x<0.167), NASICON type solid-state particles (e.g., Li_{1.4}Al_{0.4}Ti_{1.6}(PO₄)₃, Li₁₊ₓAlₓGe₂₋ₓ(PO₄)₃ (where 0≤x≤2) (LAGP)), and/or LISICON type solid-state particles (e.g., Li₂₊₂ₓZn₁₋ₓGeO₄, where 0<x<1); the metal-doped or aliovalent-substituted oxide solid-state particles may include aluminum (Al) or niobium (Nb) doped Li₇La₃Zr₂O₁₂, antimony (Sb) doped Li₇La₃Zr₂O₁₂, gallium (Ga) substituted Li₇La₃Zr₂O₁₂, chromium (Cr) and/or vanadium (V) substituted LiSn₂P₃O₁₂, and/or aluminum (Al) substituted Li_{1+x+y}AlₓTi₂₋ₓSi_{Y}P_{3-y}O₁₂ (where 0<x<2 and 0<y<3); the sulfide-based solid-state particles may include Li₂S—P₂S₅ systems (such as, Li₃PS₄, Li₇P₃S₁₁, and Li_{9.6}P₃S₁₂), Li₂S—SnS₂ systems (such as, Li₄SnS₄), Li₂S—P₂S₅—MOx systems (where 1≤x≤2), Li₂S—P₂S₅—MSx systems (where 1≤x≤2), Li₁₀GeP₂S₁₂ (LGPS), Li_{3.25}Ge_{0.25}P_{0.75}S₄ (thio-LISICON), Li_{3.4}Si_{0.4}P_{0.6}S₄, Li₁₀GeP₂S_{11.7}O_{0.3}, lithium argyrodite (Li₆PS₅X (where X is CL, Br, or I), Li_{9.54}Si_{1.74}P_{1.44}S_{11.7}Cl_{0.3}, Li_{9.6}P₃S₁₂, Li₇P₃S₁₁, Li₉P₃S₉O₃, Li_{10.35}Ge_{1.35}P_{1.65}S₁₂, Li_{10.35}Si_{1.35}P_{1.65}S₁₂, Li_{9.81}Sn_{0.81}P_{2.18}S₁₂, Li₁₀(Si_{0.5}Ge_{0.5})P₂S₁₂, Li₁₀(Ge_{0.5}Sn_{0.5})P₂S₁₂, Li₁₀(Si_{0.5}Sn_{0.5})P₂S₁₂, Li_{3.933}Sn_{0.833}As_{0.166}S₄, LiI—Li₄SnS₄, and/or Li₄SnS₄; the nitride-based solid-state particles may include Li₃N, Li₇PN₄, and/or LiSi₂N₃; the halide-based solid-state particles may include Li₃YCl₆, Li₃InCl₆, Li₃YBr₆, LiI, Li₂CdC₁₄, Li₂MgCl₄, LiCdI₄, La₂I₄, Li₃OCl, and combinations thereof; the hydride-based solid-state particles may include LiBH₄, LiBH₄—LiX (where x=Cl, Br, or I), LiNH₂, Li₂NH, LiBH₄—LiNH₂, Li₃AlH₆, and combinations thereof; and the boarate-based solid-state particles may include LI₂B₄O₇ and/or Li₂O—B₂O₃—P₂O₅.

In certain variations, the solid-state interlayer 50 may further include a polymeric polymer binder. For example, the solid-state interlayer 50 may include greater than or equal to about 80 wt. % to less than or equal to about 100 wt. %, and in certain aspects, optionally greater than or equal to about 90 wt. % to less than or equal to about 100 wt. %, of the solid-state electrolyte particles 52; and greater than or equal to about 0 wt. % to less than or equal to about 20 wt. %, and in certain aspects, optionally greater than or equal to about 0 wt. % to less than or equal to about 10 wt. %, of the polymeric binder. Example polymeric binders include polyimide, polyamic acid, polyamide, polysulfone, polyvinylidene difluoride (PVdF), poly(vinylidene fluoride-co-hexafluoropropylene) (PVdF-HFP), polytetrafluoroethylene (PTFE), polytetrafluoroethylene (PTFE) copolymers, polyacrylic acid, blends of polyvinylidene fluoride and polyhexafluoropropene, polychlorotrifluoroethylene, ethylene propylene diene monomer (EPDM) rubber, carboxymethyl cellulose (CMC), a nitrile butadiene rubber (NBR), styrene-butadiene rubber (SBR), lithium polyacrylate (LiPAA), sodium polyacrylate (NaPAA), styrene butylene styrene copolymer (SEBS), sodium alginate, and/or lithium alginate.

In certain variations, the solid-state interlayer 50 may be coated onto the positive electrode 24. For example, the solid-state interlayer 50 may cover greater than or equal to about 85%, optionally greater than or equal to about 86%, optionally greater than or equal to about 87%, optionally greater than or equal to about 88%, optionally greater than or equal to about 89%, optionally greater than or equal to about 90%, optionally greater than or equal to about 91%, optionally greater than or equal to about 92%, optionally greater than or equal to about 93%, optionally greater than or equal to about 94%, optionally greater than or equal to about 95%, optionally greater than or equal to about 96%, optionally greater than or equal to about 97%, optionally greater than or equal to about 98%, optionally greater than or equal to about 99%, and in certain aspects, optionally greater than or equal to about 99.5%, of a total surface area of a first surface of the positive electrode 24. The first surface of the positive electrode 24 opposes the negative electrode 22.

In other variations, the solid-state interlayer 50 may be coated onto a surface of the separator 26 that opposes the positive electrode 24. For example, the solid-state interlayer 50 may cover greater than or equal to about 85%, optionally greater than or equal to about 86%, optionally greater than or equal to about 87%, optionally greater than or equal to about 88%, optionally greater than or equal to about 89%, optionally greater than or equal to about 90%, optionally greater than or equal to about 91%, optionally greater than or equal to about 92%, optionally greater than or equal to about 93%, optionally greater than or equal to about 94%, optionally greater than or equal to about 95%, optionally greater than or equal to about 96%, optionally greater than or equal to about 97%, optionally greater than or equal to about 98%, optionally greater than or equal to about 99%, and in certain aspects, optionally greater than or equal to about 99.5%, of a total surface area of a surface of the separator 26 opposing the positive electrode 24.

The positive electrode 24 may be formed from a lithium-based active material that is capable of undergoing lithium intercalation and deintercalation, alloying and dealloying, or plating and stripping, while functioning as the positive terminal of a lithium-ion battery. The positive electrode 24 can be defined by a plurality of electroactive material particles. Such positive electroactive material particles may be disposed in one or more layers so as to define the three-dimensional structure of the positive electrode 24. The electrolyte 30 may be introduced, for example after cell assembly, and contained within pores of the positive electrode 24. In certain variations, the positive electrode 24 may include a plurality of solid-state electrolyte particles that are the same as or different from the plurality of solid-state electrolyte particles 52 defining the solid-state interlayer 50. In each variation, the positive electrode 24 may have an average thickness greater than or equal to about 1 μm to less than or equal to about 500 μm, and in certain aspects, optionally greater than or equal to about 10 μm to less than or equal to about 200 μm.

In various aspects, a positive electroactive material may include a layered oxide represented by LiMeO₂, where Me is a transition metal, such as cobalt (Co), nickel (Ni), manganese (Mn), iron (Fe), aluminum (Al), vanadium (V), or combinations thereof. In other variations, the positive electroactive material may include an olivine-type oxide represented by LiMePO₄, where Me is a transition metal, such as cobalt (Co), nickel (Ni), manganese (Mn), iron (Fe), aluminum (Al), vanadium (V), or combinations thereof In still other variations, the positive electroactive material may include a monoclinic-type oxide represented by Li₃Me₂(PO₄)₃, where Me is a transition metal, such as cobalt (Co), nickel (Ni), manganese (Mn), iron (Fe), aluminum (Al), vanadium (V), or combinations thereof. In still other variations, the positive electroactive material may be a spinel-type oxide represented by LiMe₂O₄, where Me is a transition metal, such as cobalt (Co), nickel (Ni), manganese (Mn), iron (Fe), aluminum (Al), vanadium (V), or combinations thereof. In still other variations, the positive electroactive material may be a tavorite represented by LiMeSO₄F and/or LiMePO₄F, where Me is a transition metal, such as cobalt (Co), nickel (Ni), manganese (Mn), iron (Fe), aluminum (Al), vanadium (V), or combinations thereof. In still further variations, the positive electroactive material may a combination of positive electroactive materials. For example, the positive electrode 24 may include one or more layered oxides, one or more olivine-type oxides, one or more monoclinic-type oxides, one or more spinel-type oxide, one or more tavorite, or combinations thereof.

In certain variations, the positive electroactive material may be optionally intermingled (e.g., slurry casted) with an electronically conductive material that provide an electron conductive path and/or a polymeric binder material that improve the structural integrity of the positive electrode 24. For example, the positive electrode 24 may include greater than or equal to about 30 wt. % to less than or equal to about 98 wt. %, and in certain aspects, optionally greater than or equal to about 60 wt. % to less than or equal to about 95 wt. %, of the positive electroactive material; greater than or equal to 0 wt. % to less than or equal to about 30 wt. %, and in certain aspects, optionally greater than or equal to about 0.5 wt. % to less than or equal to about 10 wt. %, of the electronically conducting material; and greater than or equal to 0 wt. % to less than or equal to about 20 wt. %, and in certain aspects, optionally greater than or equal to about 0.5 wt. % to less than or equal to about 10 wt. %, of the polymeric binder.

Electronically conducting materials may include carbon-based materials, powdered nickel or other metal particles, or a conductive polymer. Carbon-based materials may include, for example, particles of graphite, acetylene black (such as KETCHEN™ black or DENKA™ black), carbon nanofibers and nanotubes (e.g., single wall carbon nanotubes (SWCNT), multiwall carbon nanotubes (MWCNT)), graphene (e.g., graphene platelets (GNP), oxidized graphene platelets), conductive carbon blacks (such as, SuperP (SP)), and the like. Examples of a conductive polymer include polyaniline, polythiophene, polyacetylene, polypyrrole, and the like.

The negative electrode 22 may be formed from a lithium host material that is capable of functioning as a negative terminal of a lithium-ion battery. In various aspects, the negative electrode 22 may be defined by a plurality of negative electroactive material particles. Such negative electroactive material particles may be disposed in one or more layers so as to define the three-dimensional structure of the negative electrode 22. The electrolyte 30 may be introduced, for example after cell assembly, and contained within pores of the negative electrode 22. In certain variations, the negative electrode 22 may include a plurality of solid-state electrolyte particles that are the same as or different from the plurality of solid-state electrolyte particles 52 defining the solid-state interlayer 50 and/or the same as or different form the plurality of solid-state electrolyte particles that are optionally included in the positive electrode 24. In each instance, the negative electrode 22 (including the one or more layers) may have a thickness greater than or equal to about 0 nm to less than or equal to about 500 μm, optionally greater than or equal to about 1 μm to less than or equal to about 500 μm, and in certain aspects, optionally greater than or equal to about 10 μm to less than or equal to about 200 μm.

In various aspects, negative electrode 22 may include a lithium-containing negative electroactive material, such as a lithium alloy and/or a lithium metal. In other variations, the negative electrode 22 may include, for example only, carbonaceous materials (such as, graphite, hard carbon, soft carbon, and the like) and/or metallic active materials (such as tin, aluminum, magnesium, germanium, and alloys thereof, and the like). In further variations, the negative electrode 22 may include a silicon-based electroactive material. In still further variations, the negative electrode 22 may include a combination of negative electroactive materials. For example, the negative electrode 22 may include a combination of the silicon-based electroactive material (i.e., first negative electroactive material) and one or more other negative electroactive materials. The one or more other negative electroactive materials may include, for example only, carbonaceous materials (such as, graphite, hard carbon, soft carbon, and the like) and/or metallic active materials (such as tin, aluminum, magnesium, germanium, and alloys thereof, and the like). For example, in certain variations, the negative electrode 22 may include a carbonaceous-silicon based composite including, for example, about or exactly 10 wt. % of a silicon-based electroactive material and about or exactly 90 wt. % graphite.

In certain variations, the negative electroactive material may be optionally intermingled (e.g., slurry cast) with an electronically conductive material that provide an electron conductive path and/or a polymeric binder material that improves the structural integrity of the negative electrode 22. For example, the negative electrode 22 may include greater than or equal to about 30 wt. % to less than or equal to about 98 wt. %, and in certain aspects, optionally greater than or equal to about 60 wt. % to less than or equal to about 95 wt. %, of the negative electroactive material; greater than or equal to 0 wt. % to less than or equal to about 30 wt. %, and in certain aspects, optionally greater than or equal to about 0.5 wt. % to less than or equal to about 10 wt. %, of the electronically conducting material; and greater than or equal to 0 wt. % to less than or equal to about 20 wt. %, and in certain aspects, optionally greater than or equal to about wt. % to less than or equal to about 10 wt. %, of the one or more polymeric binders.

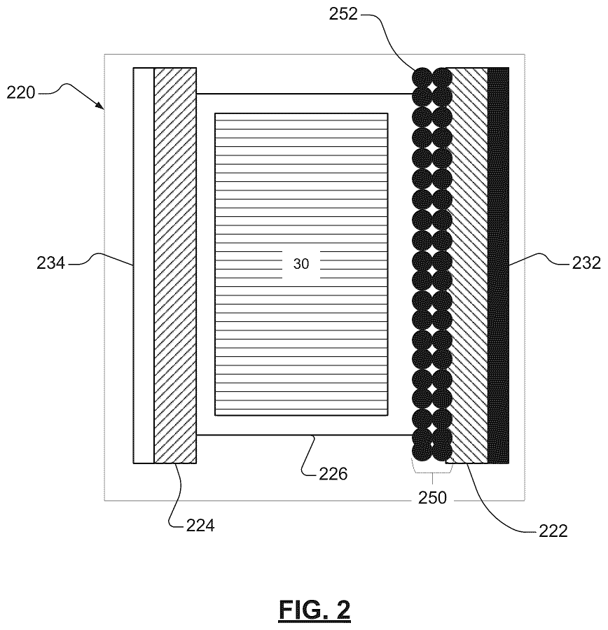

FIG. 2 illustrates another example electrochemical cell (also referred to as a battery) 220. Like the battery 20 illustrated in FIG. 1, the battery 220 may include a negative electrode 222 (e.g., anode) disposed with a first current collector 232, a positive electrode 224 (e.g., cathode) disposed with a second current collector 234, and a separator 226 that physically separates the negative electrode 222 and the positive electrode 224. In this instance, however, a solid-state interlayer 250 may be disposed between the negative electrode 222 and the separator 226. Like the solid-state interlayer illustrated in FIG. 1, the solid-state interlayer 250 may be substantially uniformed and continuous.

In certain variations, the solid-state interlayer 250 may be coated onto the negative electrode 222. For example, the solid-state interlayer 250 may cover greater than or equal to about 85%, optionally greater than or equal to about 86%, optionally greater than or equal to about 87%, optionally greater than or equal to about 88%, optionally greater than or equal to about 89%, optionally greater than or equal to about 90%, optionally greater than or equal to about 91%, optionally greater than or equal to about 92%, optionally greater than or equal to about 93%, optionally greater than or equal to about 94%, optionally greater than or equal to about 95%, optionally greater than or equal to about 96%, optionally greater than or equal to about 97%, optionally greater than or equal to about 98%, optionally greater than or equal to about 99%, and in certain aspects, optionally greater than or equal to about 99.5%, of a total surface area of a first surface of the negative electrode 222. The first surface of the negative electrode 222 opposes the positive electrode 224.

In other variations, the solid-state interlayer 250 may be coated onto a surface of the separator 226 that opposes the negative electrode 222. For example, the solid-state interlayer 250 may cover greater than or equal to about 85%, optionally greater than or equal to about 86%, optionally greater than or equal to about 87%, optionally greater than or equal to about 88%, optionally greater than or equal to about 89%, optionally greater than or equal to about 90%, optionally greater than or equal to about 91%, optionally greater than or equal to about 92%, optionally greater than or equal to about 93%, optionally greater than or equal to about 94%, optionally greater than or equal to about 95%, optionally greater than or equal to about 96%, optionally greater than or equal to about 97%, optionally greater than or equal to about 98%, optionally greater than or equal to about 99%, and in certain aspects, optionally greater than or equal to about 99.5%, of a total surface area of a surface of the separator 226 opposing the negative electrode 222.

In each variation, like the solid-state interlayer 50 illustrated in FIG. 1, the solid-state interlayer 250 may include a plurality of solid-state electrolyte particles 252. In certain variations, the solid-state electrolyte particles 252 may have an average particle size greater than or equal to about 0.02 μm to less than or equal to about 20 μm, and in certain aspects, optionally greater than or equal to about 0.1 μm to less than or equal to about 10 μm, and the solid-state interlayer 250 may have an average thickness that is at least two times the average solid-state electrolyte particle size. For example, the solid-state interlayer 250 may have an average thickness greater than or equal to about 0.5 μm to less than or equal to about 40 μm, optionally greater than or equal to about 0.5 μm to less than or equal to about 10 μm, and in certain aspects, optionally about 5 μm.

In certain variations, the solid-state electrolyte particles 252 may include, for example, Li₇La₃Zr₂O₁₂. In other variations, the solid-state particles 252 may include, for example, oxide-based solid-state particles, metal-doped or aliovalent-substituted oxide solid-state particles, sulfide-based solid-state particles, nitride-based solid-state particles, halide-based solid-state particles, and/or borate-based solid-state particles. In still further variations, the solid-state electrolyte particles 252 may include, for example, a first plurality of solid-state electrolyte particles and a second plurality of solid-state electrolyte particles, where the first plurality comprises Li₇La₃Zr₂O₁₂, and the second plurality comprises oxide-based solid-state particles, metal-doped or aliovalent-substituted oxide solid-state particles, sulfide-based solid-state particles, nitride-based solid-state particles, halide-based solid-state particles, and/or borate-based solid-state particles.

In certain variations, the solid-state interlayer 250 may further include a polymeric polymer binder. For example, the solid-state interlayer 250 may include greater than or equal to about 80 wt. % to less than or equal to about 100 wt. %, and in certain aspects, optionally greater than or equal to about 90 wt. % to less than or equal to about 100 wt. %, of the solid-state electrolyte particles 252; and greater than or equal to about 0 wt. % to less than or equal to about 20 wt. %, and in certain aspects, optionally greater than or equal to about 0 wt. % to less than or equal to about 10 wt. %, of the polymeric binder.

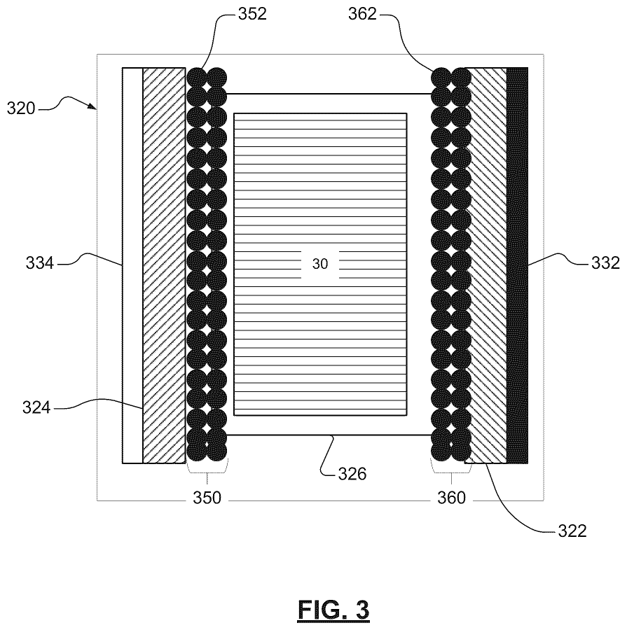

FIG. 3 illustrates another example electrochemical cell (also referred to as a battery) 320. Like the battery 20 illustrated in FIG. 1, and also, the battery 220 illustrated in FIG. 3, the battery 320 may include a negative electrode 322 (e.g., anode) disposed with a first current collector 332, a positive electrode 324 (e.g., cathode) disposed with a second current collector 334, and a separator 326 that physically separates the negative electrode 322 and the positive electrode 324. In this instance, however, a first solid-state interlayer 350 may be disposed between the positive electrode 324 and the separator 326, and a second solid-state interlayer 360 may be disposed between the negative electrode 322 and the separator 326. Like the solid-state interlayer 50 illustrated in FIG. 1 and/or the solid-state interlayer 250 illustrated in FIG. 2, the first and second solid-state interlayers 350, 360 may be substantially uniformed and continuous.

In certain variations, the first solid-state interlayer 350 may be coated onto the positive electrode 324. For example, the solid-state interlayer 350 may cover greater than or equal to about 85%, optionally greater than or equal to about 86%, optionally greater than or equal to about 87%, optionally greater than or equal to about 88%, optionally greater than or equal to about 89%, optionally greater than or equal to about 90%, optionally greater than or equal to about 91%, optionally greater than or equal to about 92%, optionally greater than or equal to about 93%, optionally greater than or equal to about 94%, optionally greater than or equal to about 95%, optionally greater than or equal to about 96%, optionally greater than or equal to about 97%, optionally greater than or equal to about 98%, optionally greater than or equal to about 99%, and in certain aspects, optionally greater than or equal to about 99.5%, of a total surface area of a first surface of the positive electrode 324. The first surface of the positive electrode 324 opposes the negative electrode 322.

In other variations, the first solid-state interlayer 350 may be coated onto a surface of the separator 326 that opposes the positive electrode 324. For example, the first solid-state interlayer 350 may cover greater than or equal to about 85%, optionally greater than or equal to about 86%, optionally greater than or equal to about 87%, optionally greater than or equal to about 88%, optionally greater than or equal to about 89%, optionally greater than or equal to about 90%, optionally greater than or equal to about 91%, optionally greater than or equal to about 92%, optionally greater than or equal to about 93%, optionally greater than or equal to about 94%, optionally greater than or equal to about 95%, optionally greater than or equal to about 96%, optionally greater than or equal to about 97%, optionally greater than or equal to about 98%, optionally greater than or equal to about 99%, and in certain aspects, optionally greater than or equal to about 99.5%, of a total surface area of a surface of the separator 326 opposing the positive electrode 322.

In certain variations, the second solid-state interlayer 360 may be coated onto the negative electrode 322. For example, the solid-state interlayer 360 may cover greater than or equal to about 85%, optionally greater than or equal to about 86%, optionally greater than or equal to about 87%, optionally greater than or equal to about 88%, optionally greater than or equal to about 89%, optionally greater than or equal to about 90%, optionally greater than or equal to about 91%, optionally greater than or equal to about 92%, optionally greater than or equal to about 93%, optionally greater than or equal to about 94%, optionally greater than or equal to about 95%, optionally greater than or equal to about 96%, optionally greater than or equal to about 97%, optionally greater than or equal to about 98%, optionally greater than or equal to about 99%, and in certain aspects, optionally greater than or equal to about 99.5%, of a total surface area of a first surface of the negative electrode 322. The first surface of the negative electrode 322 opposes the positive electrode 324.

In other variations, the solid-state interlayer 360 may be coated onto a surface of the separator 326 that opposes the negative electrode 322. For example, the solid-state interlayer 360 may cover greater than or equal to about 85%, optionally greater than or equal to about 86%, optionally greater than or equal to about 87%, optionally greater than or equal to about 88%, optionally greater than or equal to about 89%, optionally greater than or equal to about 90%, optionally greater than or equal to about 91%, optionally greater than or equal to about 92%, optionally greater than or equal to about 93%, optionally greater than or equal to about 94%, optionally greater than or equal to about 95%, optionally greater than or equal to about 96%, optionally greater than or equal to about 97%, optionally greater than or equal to about 98%, optionally greater than or equal to about 99%, and in certain aspects, optionally greater than or equal to about 99.5%, of a total surface area of a surface of the separator 326 opposing the negative electrode 322.

In each variation, like the solid-state interlayer 50 illustrated in FIG. 1 and/or the solid-state interlayer 250 illustrated in FIG. 2, the first solid-state interlayer 350 may include a plurality of first solid-state electrolyte particles 352, and the second solid-state interlayer 260 may include a plurality of second solid-state electrolyte particles 362. The first solid-state electrolyte particles 352 may be the same as or different from the second solid-state electrolyte particles 362. In certain variations, the first solid-state electrolyte particles 352, and also the second solid-state electrolyte particles 363, may have an average particle size greater than or equal to about 0.02 μm to less than or equal to about 20 μm, and in certain aspects, optionally greater than or equal to about 0.1 μm to less than or equal to about 10 μm, and the first and second solid-state interlayers 350, 360 may have average thicknesses that are at least two the average solid-state electrolyte particle size. For example, the first and second solid-state interlayers 350, 360 may have average thicknesses greater than or equal to about 0.5 μm to less than or equal to about 40 μm, optionally greater than or equal to about 0.5 μm to less than or equal to about 10 μm, and in certain aspects, optionally about 5 μm.

In certain variations, the first solid-state electrolyte particles 352 may comprise, for example, Li₁₊ₓAlₓTi₂₋ₓ(PO₄)₃, where 0≤x≤2 (LATP). In other variations, the first solid-state particles 352 may include, for example, oxide-based solid-state particles, metal-doped or aliovalent-substituted oxide solid-state particles, sulfide-based solid-state particles, nitride-based solid-state particles, halide-based solid-state particles, and/or borate-based solid-state particles. In still further variations, the first solid-state electrolyte particles 352 may include, for example, a first plurality of solid-state electrolyte particles and a second plurality of solid-state electrolyte particles, where the first plurality comprises Li₁₊ₓAlₓTi₂₋ₓ(PO₄)₃, where 0≤x≤2 (LATP), and the second plurality comprises oxide-based solid-state particles, metal-doped or aliovalent-substituted oxide solid-state particles, sulfide-based solid-state particles, nitride-based solid-state particles, halide-based solid-state particles, and/or borate-based solid-state particles.

In certain variations, the second solid-state electrolyte particles 362 may comprise, for example, Li₇La₃Zr₂O₁₂. In other variations, the second solid-state particles 362 may include, for example, oxide-based solid-state particles, metal-doped or aliovalent-substituted oxide solid-state particles, sulfide-based solid-state particles, nitride-based solid-state particles, halide-based solid-state particles, and/or borate-based solid-state particles. In still further variations, the second solid-state electrolyte particles 362 may include, for example, a first plurality of solid-state electrolyte particles and a second plurality of solid-state electrolyte particles, where the first plurality comprises Li₇La₃Zr₂O₁₂, and the second plurality comprises oxide-based solid-state particles, metal-doped or aliovalent-substituted oxide solid-state particles, sulfide-based solid-state particles, nitride-based solid-state particles, halide-based solid-state particles, and/or borate-based solid-state particles.

In certain variations, the first solid-state interlayer 350 and/or the second solid-state interlayer 360 may further include a polymeric polymer binder. For example, the first solid-state interlayer 350 and/or the second solid-state interlayer 360 may include greater than or equal to about 80 wt. % to less than or equal to about 100 wt. %, and in certain aspects, optionally greater than or equal to about 90 wt. % to less than or equal to about 100 wt. %, of the first solid-state electrolyte particles 352 or second solid-state electrolyte particles, respectively; and greater than or equal to about 0 wt. % to less than or equal to about 20 wt. %, and in certain aspects, optionally greater than or equal to about 0 wt. % to less than or equal to about 10 wt. %, of the polymeric binder.

Certain features of the current technology are further illustrated in the following non-limiting examples.

### EXAMPLE 1

Example batteries and battery cells may be prepared in accordance with various aspects of the present disclosure.

For example, an example battery cell 510 may include a solid-state interlayer and a liquid electrolyte in accordance with various aspects of the present disclosure. A comparative battery cell 520 may be prepared that is similar to the example battery cell 510, but which omits the solid-state interlayer.

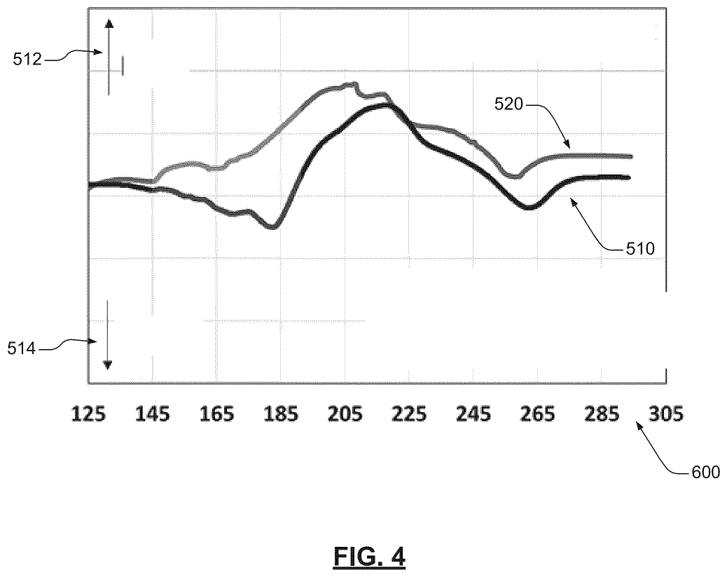

FIG. 4 is a graphical illustration demonstrating the results of a differential scanning calorimetry (DSC) test for the example battery cell 510 as compared to the comparative battery cell 520, where the x-axis 500 represents temperature (° C.), and the y-axis 502 represents heat flow (a.u.). Arrow 512 represents endothermic reaction potentials, and arrow 514 represents exothermic reaction potentials. As illustrated, exothermic reactions caused, for example, by internal short circuit (from about 145° C. to about 190° C.), have been effectively suppressed with the addition of the solid-state interlayer.

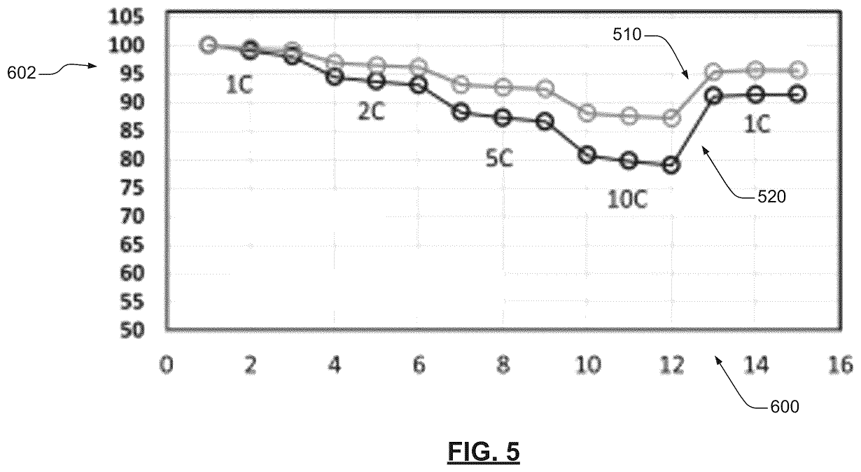

FIG. 5 is a graphical illustration representing the discharge rate capability of the example battery cell 510 as compared to the comparative battery cell 520, where the x-axis 600 represents cycle number, and the y-axis 602 represents capacity retention (%). As illustrated, the example battery cell 510 has improved rate performance as compared to the comparative battery cell 520. For example, the example battery cell 510 can deliver a capacity retention of about 88% at 10 C. current rate, which is higher than that of the comparative battery cell 520 (i.e., about 80%).

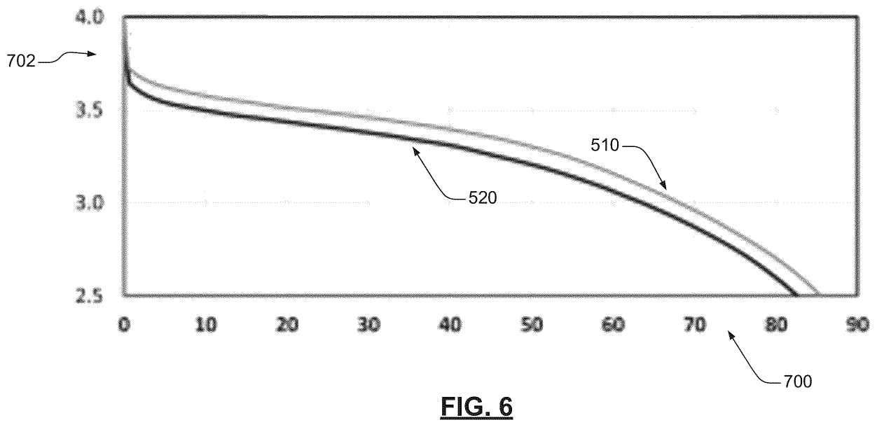

FIG. 6 is a graphical illustration representing low-temperature discharge of the example battery cell 510 as compared to the comparative battery cell 520, where the x-axis 700 represents retention (%) at 25° C., and the y-axis 702 represents voltage (V). As illustrated, the example battery cell 510 has improved low-temperature discharge capacity and a lower voltage polarization as compared to the comparative battery cell 520.

The foregoing description of the embodiments has been provided for purposes of illustration and description. It is not intended to be exhaustive or to limit the disclosure. Individual elements or features of a particular embodiment are generally not limited to that particular embodiment, but, where applicable, are interchangeable and can be used in a selected embodiment, even if not specifically shown or described. The same may also be varied in many ways. Such variations are not to be regarded as a departure from the disclosure, and all such modifications are intended to be included within the scope of the disclosure.

What is claimed is:

1. An electrochemical cell that cycles lithium ions, the electrochemical cell comprising:
an electrode;
a solid-state interlayer comprising a plurality of solid-state electrolyte particles disposed on or adjacent to a surface of the electrode; and
a liquid electrolyte disposed in the electrode and solid-state interlayer.

2. The electrochemical cell of claim 1, wherein the solid-state electrolyte particles have an average particle size greater than or equal to about 0.02 micrometers to less than or equal to about 20 micrometers, and the solid-state interlayer has an average thickness greater than or equal to about 0.5 micrometers to less than or equal to about 40 micrometers.

3. The electrochemical cell of claim 1, wherein the solid-state interlayer covers greater than or equal to about 85% of a total surface area of the surface of the electrode.

4. The electrochemical cell of claim 1, wherein the solid-state particles comprise Li₁₊ₓAlₓTi₂₋ₓ(PO₄)₃, where 0≤x≤2 (LATP) or Li₇La₃Zr₂O₁₂.

5. The electrochemical cell of claim 1, wherein the solid-state particles comprise oxide-based solid-state particles, metal-doped or aliovalent-substituted oxide solid-state particles, sulfide-based solid-state particles, nitride-based solid-state particles, halide-based solid-state particles, borate-based solid-state particles, or combinations thereof.

6. The electrochemical cell of claim 5, wherein the solid-state interlayer comprises greater than or equal to about 80 wt. % to less than or equal to about 100 wt. % of the solid-state electrolyte particles, and greater than or equal to about 0 wt. % to less than or equal to about 20 wt. % of a polymeric binder.

7. The electrochemical cell of claim 1, wherein the electrode is a positive electrode.

8. The electrochemical cell of claim 1, wherein the electrode is a negative electrode.

9. The electrochemical cell of claim 1, wherein the electrode is a first electrode, and the electrochemical cell further comprises:
a second electrode disposed parallel with the first electrode; and
a separator disposed between the solid-state interlayer and the second electrode, the liquid electrolyte also disposed in the separator and the second electrode. The electrochemical cell of claim 9, wherein the solid-state interlayer is a first solid-state interlayer, the plurality of solid-state electrolyte particles is a first plurality of solid-state electrolyte particles, and the electrochemical cell further comprises:
a second solid-state interlayer disposed between the separator and the second electrode, the second solid-state interlayer comprising a second plurality of solid-state particles, the second solid-state interlayer covering greater than or equal to about 85% of a total surface area of a surface of the second electrode opposing the separator, the second solid-state interlayer being the same as or different form the first solid-state interlayer, and the liquid electrolyte also disposed in second solid-state interlayer.

11. An electrochemical cell that cycles lithium ions, the electrochemical cell comprising:
a first electrode;
a second electrode;
a separator physically separating the first and second electrodes;
a solid-state interlayer disposed between the separator and the first electrode, the solid-state interlayer comprising a plurality of solid-state electrolyte particles; and
a liquid electrolyte disposed in each of the first electrode, the second electrode, the separator, and the solid-state interlayer.

12. The electrochemical cell of claim 11, wherein the solid-state electrolyte particles have an average particle size greater than or equal to about 0.02 micrometers to less than or equal to about 20 micrometers, and the solid-state interlayer has an average thickness greater than or equal to about 0.5 micrometers to less than or equal to about 30 micrometers.

13. The electrochemical cell of claim 11, wherein the solid-state particles are selected from the group consisting of: Li₁₊ₓAlₓTi₂₋ₓ(PO₄)₃, where 0≤x≤2 (LATP), Li₇La₃Zr₂O₁₂, other oxide-based solid-state particles, metal-doped or aliovalent-substituted oxide solid-state particles, sulfide-based solid-state particles, nitride-based solid-state particles, halide-based solid-state particles, borate-based solid-state particles, and combinations thereof.

14. The electrochemical cell of claim 11, wherein the solid-state interlayer comprises greater than or equal to about 80 wt. % to less than or equal to about 100 wt. % of the solid-state electrolyte particles, and greater than or equal to about 0 wt. % to less than or equal to about 20 wt. % of a polymeric binder.

15. The electrochemical cell of claim 11, wherein the solid-state interlayer is a first solid-state interlayer, the plurality of solid-state electrolyte particles is a first plurality of solid-state electrolyte particles, and the electrochemical cell further comprises:
a second solid-state interlayer comprising a second plurality of solid-state electrolyte particles disposed between the separator and the second electrode, the second solid-state interlayer being the same as or different from the first solid-state interlayer, and the liquid electrolyte also disposed in the second solid-state interlayer.

16. A separator for an electrochemical cell that cycles lithium ions, the separator comprising:
a porous layer having a porosity greater than or equal to about 5 vol. % to less than or equal to about 100 vol. %;
a solid-state interlayer comprising a plurality of solid-state electrolyte particles disposed on a surface of the porous layer; and
a liquid electrolyte disposed in the porous layer and the solid-state interlayer.

17. The separator of claim 16, wherein the solid-state electrolyte particles have an average particle size greater than or equal to about 0.02 micrometers to less than or equal to about 20 micrometers, and the solid-state interlayer has an average thickness greater than or equal to about 0.5 micrometers to less than or equal to about 40 micrometers.

18. The separator of claim 16, wherein the solid-state particles are selected from the group consisting of: Li₁₊ₓAlₓTi₂₋ₓ(PO₄)₃, where 0≤x≤2 (LATP), Li₇La₃Zr₂O₁₂, other oxide-based solid-state particles, metal-doped or aliovalent-substituted oxide solid-state particles, sulfide-based solid-state particles, nitride-based solid-state particles, halide-based solid-state particles, borate-based solid-state particles, and combinations thereof.

19. The separator of claim 16, wherein the solid-state interlayer comprises greater than or equal to about 80 wt. % to less than or equal to about 100 wt. % of the solid-state electrolyte particles, and greater than or equal to about 0 wt. % to less than or equal to about 20 wt. % of a polymeric binder. The separator of claim 16, wherein the surface of the porous layer is a first surface, the solid-state interlayer is a first solid-state interlayer, the plurality of solid-state electrolyte particles is a first plurality of solid-state particles, and the separator further comprises:
a second solid-state interlayer comprising a second plurality of solid-state electrolyte particles disposed on a second surface of the porous layer, the second surface being parallel with the first surface, the second solid-state interlayer being the same as or different from the first solid-state interlayer, and the liquid electrolyte also disposed in the second solid-state interlayer.
